(19) United States
(12) Patent Application Publication
(10) Pub. No.: US 2025/0317788 A1
(43) Pub. Date: Oct. 9, 2025

(54) METHOD FOR UPGRADED WI-FI USER TIERING

(71) Applicant: Adeia Guides Inc., San Jose, CA (US)

(72) Inventors: Serhad Doken, Bryn Mawr, PA (US); Dhananjay Lal, Englewood, CO (US)

(21) Appl. No.: 18/667,490

(22) Filed: May 17, 2024

Related U.S. Application Data
(60) Provisional application No. 63/574,647, filed on Apr. 4, 2024.

(51) Int. Cl. H04W 28/02; H04W 88/08

(52) U.S. Cl. CPC H04W 28/0268; H04W 88/08

(57) ABSTRACT

A Wi-Fi accessing device (STA) may be determined to be entitled to premium status on a Wi-Fi service network because the STA is located in a premium area, for example, in a VIP lounge, of the Wi-Fi coverage area, or because, for example, as indicated by a network server, the STA is associated with a user profile with premium status. A Wi-Fi access point (AP) may then transmit to the first STA an information element indicating the premium status and implement one or more measures to provide enhanced quality of service (QoS) for the STA. The AP may thus provide tiered QoS over the W-Fi network. As the STA travels through the same Wi-Fi network or to a second Wi-Fi network, a second AP of that second Wi-Fi network may also implement enhanced QoS for the STA.

### CROSS-REFERENCE TO RELATED APPLICATIONS

This application claims benefit to U.S. Provisional Application No. 63/574,647, filed Apr. 4, 2024. The disclosure of which are hereby incorporated by reference herein in its entity.

### SUMMARY

The present disclosure relates to improving Wi-Fi network communication and, in particular, to improving quality of service (QoS) for one or more Wi-Fi accessing devices that are selected based on predetermined parameters.

### BACKGROUND

Wi-Fi networks are used in many public, private, and other places to provide access to the Internet and other network communication by Wi-Fi capable or certified devices, also referred to herein as ‘Wi-Fi accessing devices” and as “Wi-Fi network accessing devices,” including mobile devices, computers, telephones, streaming media players, smart TVs, voice assistant systems, smart home devices, tablets and the like. Wi-Fi hotspots may be provided at shopping centers, hotels, stadiums, office buildings, and more. Service providers and/or owners of wireless routers and other Wi-Fi equipment often want control over access to and/or uses of their hotspots.

A technological problem that arises is that numerous devices may access a Wi-Fi network at once so that each device must contend for limited network bandwidth and other network resources. This may create latency of transmissions, packet collisions, dropped connections, application level timeouts that translate to inability to load content, and other such issues for devices using the network. In addition, any given device on the Wi-Fi network may experience such latency and the other issues unpredictably at seemingly random times. Thus, communications over a Wi-Fi network may be unreliable, depending on the number of devices connecting to the network at any given time.

In one approach, devices connect to Wi-Fi using different SSIDs. A first SSID, available to a first group of users, may provide a different level of service than a second SSID available to a second group of users. However, this approach requires that personnel of the establishment that owns or manages the Wi-Fi network keep track of which users receive instructions to access Wi-Fi using which SSID. For example, using such an approach a hotel clerk has to make sure that executives using the boardroom receive instructions to access the Wi-Fi using the first SSID while other guests of the hotel receive instructions to access Wi-Fi using the second SSID but do not receive the instructions to access the Wi-Fi using the first SSID. If the wrong Wi-Fi SSID and password are shared with a person, a user may not get access to the appropriate level of service such as bandwidth, latency may be increased, and other such network issues may ensue. Even if the credentials (e.g., username and password) expire at a certain time, that user may be unable to move readily from one network to another without manual intervention.

Another approach that tries to differentiate free or premium users follows the method of setting ingress/egress minimum/maximum bandwidth parameters on an Access point (AP). FIG. 2 shows an approach to differentiate free or premium users by assigning IP addresses that have minimum/max bandwidth limits. However, this approach focuses solely on network speed and does so by limiting bandwidth available to non-premium users, but does not leverage the resources of the wireless network to enhance service for devices with premium status. While this is helpful, it is rather primitive approach that focuses on just speed and does not leverage resources of the wireless medium to provide tiered service. Also, such an approach may limit the maximum bandwidth available for non-premium devices, but it does not enhance the quality of service provided to premium devices.

Another problem is that an organization may wish to provide a higher quality of service for accessing Wi-Fi on an on-going basis—even for more than one Wi-Fi network. For example, an organization may wish to make an arrangement with a hotel chain to have the organization's employees receive an enhanced quality of service when using Wi-Fi, regardless of which hotel they visit. Thus, there is a need for an ability for premium status affording improved quality of service that “travels with” a device, such as a smartphone, in a manner agnostic as to which Wi-Fi network, or what type of Wi-Fi equipment the employee is accessing.

There is also a need to offer different Wi-Fi user tiers in Enterprises, stadiums, venues, conference halls or many wide coverage areas without going through the hassle of creating SSIDs and instructing users to login particularly to those SSID networks or select different options on a splash page. Moreover, given that today's Wi-Fi network setup is primarily based on mesh architecture (Wi-Fi 6e, 802.11ax), using the same SSID across the mesh APs may bring a benefit.

According to an aspect of the disclosure, an access point (AP) of a Wi-Fi network, such as a wireless router or gateway, may determine that Wi-Fi accessing devices located in a particular area within the Wi-Fi range of the AP are entitled to premium status. The location of Wi-Fi accessing devices may be determined in one or more ways by the AP or by the AP together with other devices.

The AP may then transmit to the Wi-Fi accessing device an information element, for example, a code in a management frame, to provide access to the premium status. The Wi-Fi accessing device may then identify itself to the AP using the information element to obtain enhanced quality of service, or an identifier of the Wi-Fi accessing device, such as a MAC address, may be stored by the AP and thus the AP may recognize the Wi-Fi accessing device as having premium status at each new communication session.

For example, devices of users may be designated to receive enhanced quality of service on the Wi-Fi network because there may be a need to provide a different user experience over the same Wi-Fi network for different classes of users. For example, a hotel may wish to provide better quality of service to business people in a boardroom than to guests of the hotel at large, or a stadium may wish to provide Wi-Fi to all visitors but may wish to provide higher quality of service to higher paying guests in the VIP suites. Another example is a meeting room at a company where an important meeting or even a technical demo is being shown and users in that room should be offered an upgraded Wi-Fi experience compared to other meeting rooms. A hotel/venue operator may want to offer an upgraded experience in a meeting room compared to other rooms without having to distribute a different Wi-Fi SSID/username and password. Yet another example is an airline operator that may want to offer an upgraded Wi-Fi experience for passengers sitting in the first/business class section compared to everybody else on the airplane despite using the same SSID such as “AAInFlight.” A large public venue operator such as Las Vegas Convention Center may want to differentiate users in a room conducting a panel session versus conference attendees who are at the food court. The Wi-Fi accessing device with premium status may thus have better quality of service (QoS) then another W-Fi accessing device using the same service set identifier (SSID, sometimes referred to herein as a Wi-Fi service network or as Wi-Fi service set).

In an embodiment, the AP may receive a request over a wired network from a server to provide premium status to one or more Wi-Fi accessing devices of the Wi-Fi network. For example, the AP may transmit to the server a MAC address, or other information identifying a device accessing the Wi-Fi network, and, in response, the server may access a database that contains a list of devices associated with people or devices entitled to premium status. The server may then transmit a request the AP to provide the premium status to the Wi-Fi accessing device.

Enhanced quality of service may be effectuated for a Wi-Fi accessing device in a number of ways. For example, a higher frequency band of the spectrum within the Wi-Fi network may be reserved for one or more Wi-Fi accessing devices entitled to the premium status. Fewer premium status Wi-Fi accessing devices may be assigned to communicate in a portion of the radio frequency band than in the radio frequency band used by Wi-Fi accessing devices that are not designated for premium status. Antenna beam steering may be used by the AP to favor the location of premium status Wi-Fi accessing devices. Enhanced modulation and encoding schemes may be used for premium status Wi-Fi accessing devices compared to the modulation and encoding schemes used for Wi-Fi accessing devices that are not premium status. The AP may predict to which next AP a handover of the premium status Wi-Fi accessing device is likely, and then signal the next AP to prepare it to receive communications of the premium status Wi-Fi accessing device.

Described are an apparatus, system, non-transitory computer readable medium, method and means for implementing a method of enhancing quality of service for select Wi-Fi accessing devices. Such a method may include: determining that a first Wi-Fi accessing device is associated with a premium status on a Wi-Fi service network; causing a Wi-Fi access point (AP) to transmit to the first Wi-Fi accessing device an information element indicating the premium status; receiving an indication of communication from the first Wi-Fi accessing device at the AP; causing the AP to provide a first level of service for communication between the first Wi-Fi accessing device and the AP according to the premium status indicated by the information element, wherein the first level of service provides enhanced quality of service for communications of the first Wi-Fi accessing device compared with a second level of service on the Wi-Fi service network provided for communications of a second Wi-Fi accessing device.

The premium status may be recognized by a second Wi-Fi service network, for example, when the first Wi-Fi accessing device travels to a new location, a new AP (sometimes referred to as a second AP) may contact a webserver that stores premium status information for devices, or for users associated with Wi-Fi accessing device, to determine whether a MAC address of the first Wi-Fi accessing device has been accorded Wi-Fi status. In addition, or instead, the new AP may determine whether the first Wi-Fi accessing device transmits a token that shows that the first Wi-Fi device has been granted the premium status.

Such a method may include: receiving an indication of a second communication from the first Wi-Fi accessing device, wherein the second communication comprises the information element and is received over a second Wi-Fi service network by a second AP remote from the first AP, wherein the second Wi-Fi service network is remote from the first Wi-Fi service network; and causing the second AP to provide the first level of service on the second Wi-Fi service network for communications of the first Wi-Fi accessing device, wherein the second AP provides the second level of service on the Wi-Fi service network for communication between a third Wi-Fi accessing device and the second AP.

Causing the AP to transmit to the first Wi-Fi accessing device the information element may include: determining by a server that the first Wi-Fi accessing device is eligible for the premium status; and transmitting, by the server, a request to the AP to transmit to the first Wi-Fi accessing device the information element conferring the premium status. Or, the information element may be previously stored in the first Wi-Fi accessing device, for example, a user may be given an access code, password, barcode or the like which may be scanned by or otherwise entered in the first Wi-Fi accessing device and transmitted to the AP. Or, the access code, password, barcode or the like may be entered in the first Wi-Fi accessing device, and then the first Wi-Fi accessing device may transmit it to a webserver and stored there and later accessed by the AP.

The premium status may be time-bound or otherwise conditional. It may be determined that the premium status of the first Wi-Fi accessing device expires after a period of time; and the AP may be caused to provide the second level of service on the Wi-Fi service network for communications of the first Wi-Fi accessing device with the AP.

Premium status may be determined based on one or more criteria. It may be determined that the first Wi-Fi accessing device is located in a first physical area different from a second physical area, wherein the first physical area and the second physical area are within a signal range of the Wi-Fi service network. The second level of service on the Wi-Fi service network for communications of the second Wi-Fi accessing device with the AP may be allocated by determining that the second Wi-Fi accessing device is located in the second physical area.

A first MAC address of the first Wi-Fi accessing device may be stored in memory by the AP and/or may be stored by a webserver. After receiving a signal from the first Wi-Fi accessing device, it may be determined that the first Wi-Fi accessing device has a MAC address that matches the first MAC address. Also, if a Wi-Fi network has more than one AP, the AP may transmit the MAC address of the first Wi-Fi accessing device to the rest of the APs of the Wi-Fi network and indicate premium status for the Wi-Fi accessing device.

The enhanced quality of service may be achieved in one or more ways. A first radiofrequency band of the Wi-Fi service network may be allocated to a first plurality of Wi-Fi accessing devices, including the first Wi-Fi accessing device, for communicating with the AP, and causing allocation of a second radiofrequency band of the Wi-Fi service network to a second plurality of Wi-Fi accessing devices, including the second Wi-Fi accessing device, for communicating with the AP. For example, the AP may selectively advertise the first radio frequency band on the Wi-Fi service network.

In addition, or instead, the enhanced quality of service for the first Wi-Fi accessing device may be obtained by: causing allocation of a first resource unit of the Wi-Fi service network to the first Wi-Fi accessing device, and causing allocation of a second resource unit of the Wi-Fi service network to the second Wi-Fi accessing device, such that the first resource unit provides a higher modulation coding scheme than does the second resource unit.

In addition, or instead, the enhanced quality of service for the first Wi-Fi accessing device may be obtained by: steering an antenna radio beam of the AP to favor communications at a location of the first Wi-Fi accessing device. The location of the first Wi-Fi accessing device may be known in a variety of ways.

In addition, or instead, the enhanced quality of service for the first Wi-Fi accessing device may be obtained by: communicating to a second AP to anticipate handoff of the first Wi-Fi accessing device from the first AP to the second AP. The second AP may thus anticipate communication from, or initiate communication with the first Wi-Fi accessing device, and may know in advance a location of the first Wi-Fi accessing device, an identifier of the first Wi-Fi accessing device, and other information about the first Wi-Fi accessing device and/or about an ongoing communication (e.g. a streaming video in progress) of the first Wi-Fi accessing device.

In addition, or instead, the enhanced quality of service for the first Wi-Fi accessing device may be obtained such that the second level of service is free of a maximum bandwidth egress limitation controlled by a setting of the AP for the second Wi-Fi accessing device and free of a maximum bandwidth ingress limitation controlled by a setting of the AP for the second Wi-Fi accessing device. Such bandwidth limitations may be imposed for the second Wi-Fi accessing device and other non-premium status Wi-Fi accessing devices of the Wi-Fi network.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following Figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A illustrates an example of a Wi-Fi network with a Wi-Fi access point (AP) and Wi-Fi accessing devices in a designated area in which it is granted premium quality of service, according to an aspect of the disclosure;

FIG. 1B illustrates an example of the Wi-Fi network with select Wi-Fi accessing devices granted premium quality of service based on received parameters, according to an aspect of the disclosure;

FIG. 2 illustrates an example of basic bandwidth control on a router in a Wi-Fi network;

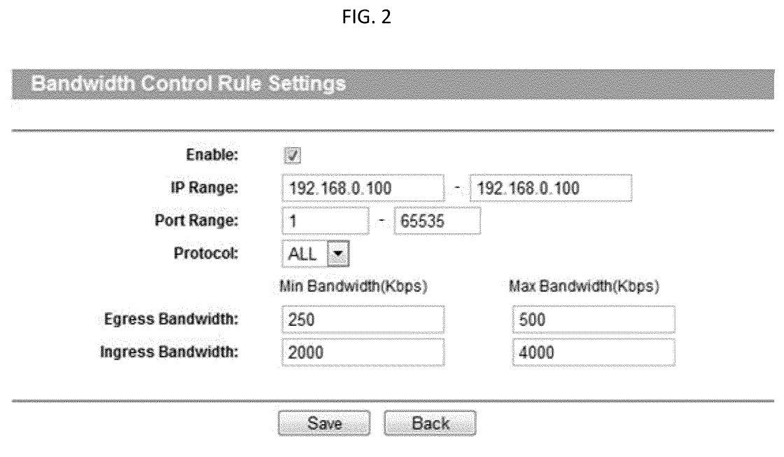

FIG. 3 illustrates an example of communication sequence between a Wi-Fi accessing device (sometimes referred to as station or STA) and an AP for determining a position of the Wi-Fi accessing device by fine-tuning measurement, according to an aspect of the disclosure;

FIG. 4 illustrates an example of determining the ranging of a Wi-Fi accessing device using trilateration by several APs, according to an aspect of the disclosure;

FIG. 5 illustrates an example of a computer system for implementing methods described herein, according to an aspect of the disclosure;

FIG. 6 illustrates a server connected to a database communicating with other nodes via a network, according to an aspect of the disclosure;

FIG. 7 illustrates an example of a communication and processing diagram, according to an aspect of the disclosure;

FIG. 8 is a flowchart showing an example of a process for determining premium status for a Wi-Fi accessing device and for providing enhanced quality of service, according to an aspect of the disclosure;

FIG. 9 illustrates an example of a communication and processing diagram for a backend server to authorize an AP to grant premium status for a Wi-Fi accessing device, according to an aspect of the disclosure.

### DETAILED DESCRIPTION

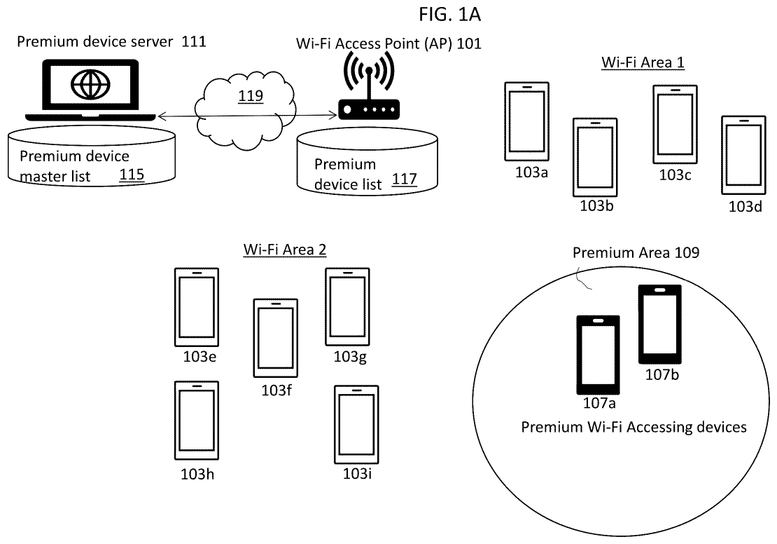

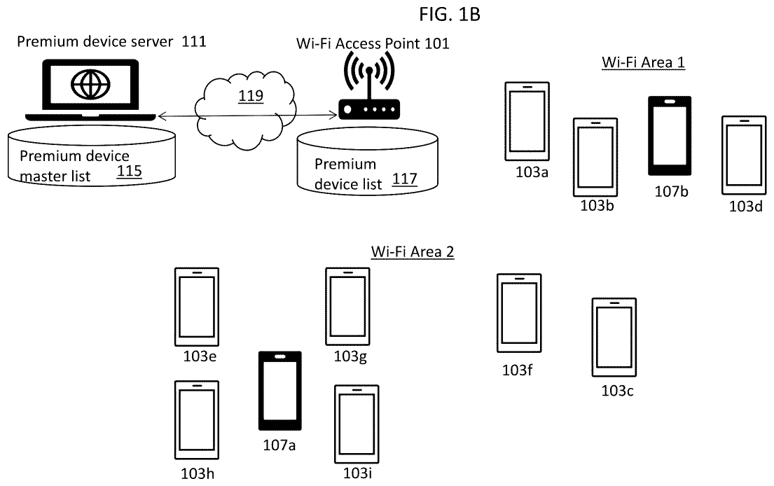

FIG. 1A illustrates a Wi-Fi access point 101 that provides a Wi-Fi access area, sometimes referred to as a hotspot, for one or more Wi-Fi access devices 103a-103i and also 107a, 107b to connect to the Wi-Fi access point 101. For example, the Wi-Fi access point (AP) may be a wireless router that is connected by a wired connection to the Internet or other network 119. As also shown in FIG. 1, the Wi-Fi area also include a premium Wi-Fi accessing area 109 which contains Wi-Fi accessing devices 107a, 107b. As various Wi-Fi accessing devices enter the Wi-Fi area and connect to the Wi-Fi network provided by the AP 101, AP may determine whether the location of each Wi-Fi accessing device is in the premium area 109. If the Wi-Fi accessing device is determined to be located in the premium area 109, then AP 101 may assign it premium status and upgraded its quality of service.

In an implementation, AP 101 may determine whether the Wi-Fi accessing device is located in the premium area 109 for at least the threshold amount of time, for example 2 to 180 second, before the device receives premium status. For example, a hotel guest who happens to stray briefly into the premium area 109, or uses a facility not ordinarily available to hotel guests other than business people who use the boardroom of the hotel, may this be prevented from being granted premium status. Thus, the AP may automatically redetermine the location of the Wi-Fi accessing device after a set period of time, or upon the occasion of the next communication, or attempted communication, by the Wi-Fi accessing device with the AP. The AP grant the premium status only if at this subsequent time the Wi-Fi accessing device is still in the premium area 109.

The AP 101 may contact premium device server 111 each time a Wi-Fi accessing device 103a-103i, 107a, 107b attempts to communicate with the AP 101 to determine whether the Wi-Fi accessing device is entitled to premium status. For example, a credit card company or another organization may maintain a premium device master list 115 that identifies devices of customer or employees who are entitled to premium status, for example, as privileged credit card holders, or as employees or executives of the company, or the like. Or, a hotel may wish to award premium status to customers who have accrued a certain number of loyalty points. The AP 101 may communicate to the premium device server 111 identifying information, such as a MAC address, for the Wi-Fi accessing device, or identifying information for a user associated with the Wi-Fi accessing device. For example, the AP may request user profile data from the Wi-Fi accessing device or may request credentials, such as rewards program or employee ID and password from the user of the Wi-Fi accessing device. In response the premium device server 111 may inform the Wi-Fi access point 101 whether or not the Wi-Fi accessing device is entitled to premium status. Or, the premium device server 111 may, periodically or in response to AP request, push notification to the Wi-Fi access point 101 a list of devices that are entitled to premium status.

The AP 101 may keep track in a local premium device list 117 the wireless the Wi-Fi accessing devices that are entitled to premium status in its network. In an implementation, once a Wi-Fi accessing device is determined to be entitled to premium status, the premium status remains with the Wi-Fi accessing device the next time the Wi-Fi accessing device communicates with the AP. Similarly, the premium device server 111 may maintain a Wi-Fi accessing device that has been granted premium status on its premium device master list 115 for future communications of the Wi-Fi access in device. In this sense, the premium status may “travel with” the Wi-Fi accessing device as it travels and uses various Wi-Fi access points.

FIG. 1B illustrates an example of an embodiment in which the client may invoke the initiation and set-up of a premium service when an application (e.g., sports application) is launched. Premium status may be driven or requested by the STA. A client may derive its premium status from an application-level entity such as an app (NBA team, American Airlines app, Marriott Bonvoy membership app, etc.). For example, a server associated with the app may generate and issue a token to the client that allows it to request and gain access to a premium Wi-Fi service. Such token may be accessible to APs for authorization.

In an implementation, the premium status of the Wi-Fi accessing device may be conditional. For example, premium status may be indicated for a period of time, for example, one hour, or one day, or a week-long conference, or may expire on the occurrence of an event, for example, when a user associated with the Wi-Fi accessing device checkout of a hotel, cancels membership in a gym, cancels a credit card, leaves employment in a company, or the like. In some instance, premium status may be granted for a Wi-Fi accessing device only while located within the premium area 109. For example, an organization may contract with a hotel chain to grant premium status to devices of employees when the devices are using the boardroom (premium area 109) but not during off hours. By way of further example, premium status may be conditioned on an action that a user of the Wi-Fi accessing device has to take while communicating with the AP 101 or the server 111, such as completing a survey, consuming ads, paying a fee for a premium service upgrade, or paying a fee for a temporary premium service upgrade. In addition, or instead, premium status may be conditional in that premium status may be granted for a set quantity of communication time and/or a set data amount, and at the expiration of the time or the exhaustion of the quantity of data, the premium status may be automatically withdrawn for the device. Two or more such conditions may be applied in combination to a Wi-Fi accessing device and/or may be applied to a user associated with a Wi-Fi accessing profile.

In one embodiment, users, such as network administrators, may enable a “Premium User Tiering” service on one or more Wi-Fi access points associated with a location. Such designation may include clicking a checkbox on an AP management interface or a cloud interface that manages a set of mesh APs. This results in the creation of an information element (IE), such as 802.11u management frame, to indicate during the communication from the AP to STAs (e.g., mobile stations) that the AP is capable of granting premium tiering. Depending on the size of the location (e.g., venue/room), network admins may set a radius threshold as well. This could be simply a checkbox on the AP management interface or a cloud interface that manages a set of mesh APs. Then, this setting is converted to the IE to indicate during the communication from this AP to STAs that this STA is granted premium tiering.

Depending on the size of the venue/room where this location-focused feature is offered, a radius may be set. This may be set by simply selecting a checkbox on the AP management interface or a cloud interface that manages a set of mesh APs.

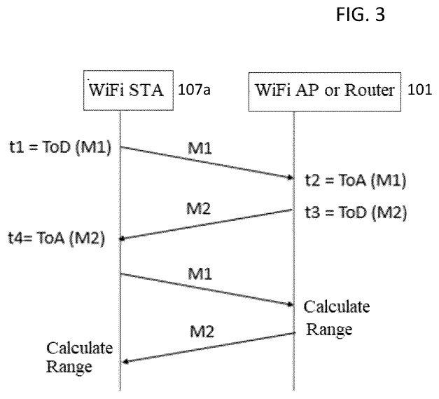

In one embodiment, an AP may derive the positioning of the STAs that are authenticated with it. An example of estimating a position of the STA is shown in FIG. 3. This can be implemented using Wi-Fi fingerprinting. A fingerprint typically contains channel state information (CSI), such as a received signal strength indicator (RSSI) or a channel estimate from a received signal, measured at a specific location in an environment. The position of the mobile device or STA may be estimated in a multipath environment, given a known time-of-departure (ToD), using time-of-arrival (ToA)/time-of-flight (ToF), or other spatial info such as AoA (Angle of Arrival) measurements to calculate range of the Wi-Fi STA, as shown in FIG. 3

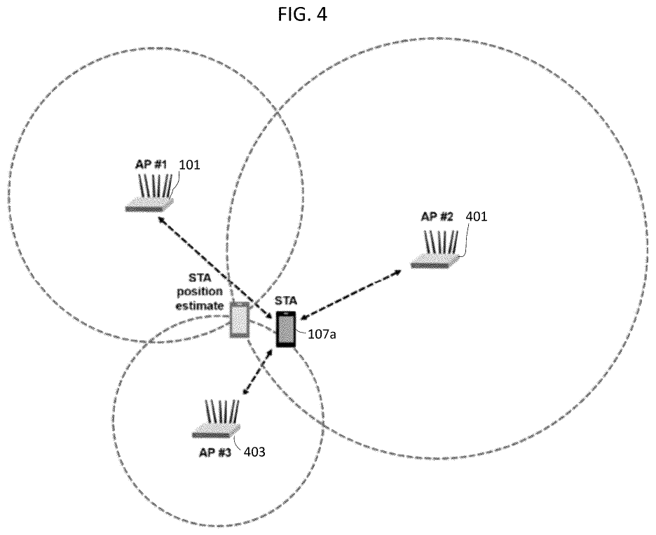

When the locations of at least three devices are known with respect to each other, trilateration may be used to compute the position estimate of a fourth device within range of the three devices. An example of this is shown in FIG. 4. Once an access point determines that one more STAs are within the allowed radius set by the admin, the IE will be communicated to the one or more STAs that they will be treated at the premium tier level. The access point will record the MAC addresses of the in-range STAs. Other STAs detected beyond this range may not receive the aforementioned IE.

In one embodiment, an AP that is providing a premium tier service may continue to track the STAs in terms of ranging. The STAs that received the IE (Information Element) and were upgraded to the premium tier may keep using the IE while communicating with all the APs that are using or associated with the same SSID. The Wi-Fi network may utilize fingerprinting and deep-learning techniques to achieve sub-meter accuracies even in non-line-of-sight (NLOS) multipath environments between the host AP and neighboring APs and STAs. Consistent, periodic ranging over time provides a velocity vector for each STA.

One or more measures may be taken to enhance QoS, including, but not limited to, one or more of the techniques described herein. Based on the granular distribution of premium STAs within the set radius, a first access point (e.g., AP#1) may employ beam steering to provide better RF coverage to the premium STAs by building granular radiation patterns. Beam steering may be implemented using either active or phased array antennas on the APs to change a direction of the main lobe of a radiation pattern. Since the location and distance range as well as DoA (direction of arrival) data of the premium STAs may be known for a premium status location or for a premium status STA, narrow beams maybe constructed to provide better RF coverage for these STAs especially if they are detected to be static using MIMO antennas of AP#1. If they are detected to be mobile, adaptive beam steering may be employed based on the speed, changing location and location distribution of the premium STAs. Beam steering may also be fine-tuned in terms of computing what STAs are in line of sight using the CSI matrix by looking at phase and amplitude weights.

In on embodiment, if the mesh APs and STAs are MLD (multi-link devices) and have the MLO (Multi-Link Operation) implemented, mesh APs may assign or communicate with the premium STAs to a higher frequency range spectrum link such as 6 GHz (preferably) and/or enable the channel aggregation of multiple links such as 5 Ghz and 6 GHz channels, whenever needed/applicable. STAs not having the premium tier IE may still be assigned to 2.4 or 5 GHz channels. During the negotiation for MLO, APs may advertise the available bands while clients may, due to the requirement for having autonomous control of their power consumption, may select the actual bands to be used. To modify this procedure, Wi-Fi APs may selectively advertise links to the STAs based on their status (standard status/premier status). Bands and channels with greater interference (lower SNR) are advertised to non-premium customers, while channels capable of higher throughput may be reserved for advertisement to premium customers.

In yet another embodiment, OFDMA divides a Wi-Fi channel into smaller frequency allocation, or groups of sub-carriers known as Resource Units (RUs). These individual RUs may be assigned to different stations, which allows APs to serve them simultaneously during uplink and downlink transmissions. In one embodiment, RUs are categorized based on quality (e.g., based on measurements of signal to noise ratio (SNR), bit error rate (BER), block error rate (BLER) etc. The higher quality RUs may be then allocated for premium users (Tx and Rx) while the lower quality RUs are used by non-premium customers, in the schedule communicated by the AP (RU allotments in both downlink and uplink directions are performed by the AP). For example, RUs having a higher Modulation Coding Scheme (MCS) Index may be reserved by the AP for premium customers, while RUs that have lower MCS index may be used for non-premium customers. Since each STA/client typically communicates with an AP only using one MCS index across all RUs, the AP picks a set of RUs with lower MCS for allocation to a non-premium STA in its OFDMA schedule. the scheduling problem in OFDMA has been tackled by the research community using multiple proposed methods that try to optimize a utility function subject to some constraints. In this embodiment, the RUs may be divided into subsets based on quality (such as BER, or a derived metric such as MCS) and a separate scheduler algorithm may thus be run for each of these sets of RUs for premium and non-premium customers.

If premium STAs and non-premium STAs end up using the same frequency and same channel, a prioritized queue may be constructed and shared by the APs and STAs. When a premium STA is transmitting on a channel that a non-premium STA is also using, premiums STAs may be enabled to capture and reserve the channel until they finished transmitting their packets. Non-premium STAs may thus need to wait for their communication to be complete. Wi-Fi 7 has Restricted Service Periods (RSPs) for deterministic latency that may be allocated preferentially to premium customers.

In an embodiment, an access point may determine that a premium service STA is moving away from it and, based on the ranging data of the STA with respect to other APs (e.g., AP#2, AP#2, etc.), the access point may determine which AP or APs are closer to the STA and communicate to other APs that the STA is approaching to prepare for the handover. The first AP may communicate to the STA in the Access Network Query Protocol (ANQP) message the range/distance of other APs. To-be roamed AP (e.g., AP#3) may start or initiate a fast Basic Service Set (BSS) transition with the first access point by redefining the security key negotiation protocol, allowing both the negotiation and requests for wireless resources. Premium STAs that will be roaming may either compute the range of a neighboring AP themselves or alternatively may be informed by the access point that they are currently connected to (e.g., first access point) what channels the AP that they will be moving towards operates and thus they can avoid channel scanning, improving their performance.

In an embodiment, the new host AP (e.g., AP#3) is not a premium granting AP but when it receives the premium information element from the roaming STAs, it may then employ the beam steering, radio resource advertisement and allocation as well as MLO link steering procedures explained earlier. This means, premium STAs even after they are no longer connected to the premium granting AP, may still be treated by other APs using the same SSID in a premium fashion.

In an embodiment, a connectivity provider may implement policies in the Wi-Fi network, such as, what proportion of the bandwidth shall be used by premium customers vs. non-premium customers. In such cases, a fairness algorithm, such as customer-class-based weighted fair queueing, may be used. This may ensure, that no customer class suffers from starvation, yet the bandwidth allocation may be weighted heavily in favor of the premium users. If a premium customer is moving in a direction where the to-be-roamed AP is heavily loaded already with other premium customers, then it may delay the handoff or choose another AP from a set of redundantly available APs. The chosen AP may not be optimum from a channel quality or proximity standpoint, but it may have more headroom for allowing premium traffic loading than the other AP which was closer.

For example, consider a premium STA that is being served by a network where each AP allocates up to 80% of the bandwidth for premium customers. Currently, it uses up to 15% of the bandwidth at an AP, say APo. When it moves away from APo, it may be served by APx or APy, based on its direction of movement. APx is already loaded to 70% of the premium customers' allocated capacity, while APy is loaded to 55% of premium customers' allocated capacity. Then the system shall pick APy to serve this STA as it moves out of range of APo. This way we may achieve client load balancing based on the Wi-Fi user tiering as well as selective roaming based on this load balancing situation.

If an STA device is disconnected from the network or no longer connected to the SSID (either manually by the user or losing RF connection), the premium IE frame may be discarded which means this STA may have to be detected again by the original location AP in order to regain its premium status. In an embodiment, an identifier of the STA device is stored in a database for future connections of the STA device to this Wi-Fi network or to other Wi-Fi networks.

The client may populate the management frame IE with the token. This token may be coded or scrambled (encryption or hashed) and may include details about the particular customer (royalty number, subscriber ID, flight number, membership number, etc.), duration of access, tier information, etc. When in range, an STA client may communicate the coded token to an AP and the AP may receive the token and transmit the token to an authentication server that may verify its authenticity. If/when verified, the AP may accept the client initiated premium management frame IE from the STA, record the MAC address and grant connectivity to the STA or user device. The token provided from the application may also be coded in a fashion to assign further hierarchical tiering of premium STAs and when decoded may instruct the AP to perform certain operations.

For instance, beam-steering may only be offered for some STAs. Thus, there may be three or more tiers: standard tier; premium tier with enhanced quality of service obtained using one or more of the QoS enhancing techniques described herein; and a VIP premium tier with a more enhanced QoS obtained using two or more of the QoS enhancing techniques described herein, e.g. including such techniques as beam steering.

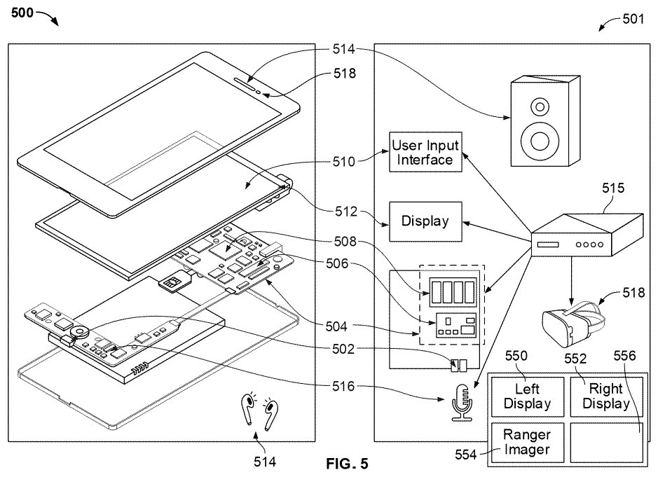

FIG. 5 illustrates an example of an implementation of a device 101, 111, 103 or 107, including some components thereof. A circuit board may include control circuitry, processing circuitry, and storage (e.g., RAM, ROM, hard disk, removable disk, etc.). In some embodiments, the circuit board may include an input/output path for communicating with the controller 916. Each device 500/501 may receive content and data via input/output (I/O) path 512 that may comprise I/O circuitry (e.g., network card, or wireless transceiver). I/O path 512 may communicate over a local area network (LAN) or wide area network (WAN), for example, via Wi-Fi, Bluetooth, cellular or other wireless or wired connection.

Control circuitry 518 may comprise processing circuitry 520 and storage 522 and may comprise I/O circuitry. Control circuitry 518 may be used to send and receive commands, requests, and other suitable data using I/O path, which may comprise I/O circuitry. I/O path may connect control circuitry 518 (and specifically processing circuitry) to one or more communications paths (described below). I/O functions may be provided by one or more of these communications paths but are sometimes shown as a single path to avoid overcomplicating the drawing.

Control circuitry 518 may be based on any suitable control circuitry such as processing circuitry 520. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 518 executes instructions for various applications, including the XR application, stored in memory (e.g., storage 522). Specifically, control circuitry 518 may be instructed by the XR application to perform the functions discussed above and below

In some client/server-based embodiments, control circuitry 518 may include. communications circuitry suitable for communicating with other networks. The instructions for performing any of the embodiments discussed herein may be encoded on non-transitory computer-readable media (e.g., a hard drive, random-access memory on a DRAM integrated circuit, read-only memory etc.). For example, the instructions may be stored in storage 518, and executed by control circuitry.

Control circuitry 518 may include communications circuitry suitable for communicating with a server, XR equipment controller and devices, a table or database server, or other networks or servers. Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device provided as storage 522 that is part of control circuitry 518. As referred to herein, the phrase “electronic storage device” or “storage device” should be understood to mean any device for storing electronic data, computer software, or firmware, such as random-access memory, read-only memory, hard drives, optical drives, digital video recorders, solid state devices, quantum storage devices, gaming consoles, or any other suitable fixed or removable storage devices, and/or any combination of the same. Storage 522 may be used to store various types of content described herein. Nonvolatile memory may also be used (e.g., to launch a boot-up routine and other instructions).

Control circuitry 518 may include video generating circuitry and tuning circuitry. Control circuitry 518 may also include scaler circuitry for upconverting and down converting content into the preferred output format of equipment 500. Control circuitry 518 may also include digital-to-analog converter circuitry and analog-to-digital converter circuitry for converting between digital and analog signals. In some embodiments all elements of system 500 may be inside housing of the XR display device 518. In some embodiments, device 518 comprises a camera 556 (or a camera array or LiDAR-Light Detection and Ranging). Video cameras may be integrated with the equipment or externally connected. One or more of cameras may be a digital camera comprising a charge-coupled device (CCD) and/or a complementary metal-oxide semiconductor (CMOS) image sensor. In some embodiments, one or more of cameras 556 may be dirtied at outside physical environment (e.g., two cameras may be pointed out to capture to parallax views of the physical environment). In some embodiments, device may comprise one or more biometric sensor or sensors to measure eye rotation (e.g., electrodes to measure eye muscle contractions) and head movement. In some embodiments, HMD 518 comprises left display 550, right display 550 (or both) for generating VST images.

The controller may be implemented using any suitable architecture. For example, it may be or may include a stand-alone application wholly implemented on each one of equipment device 500 and user equipment device 501. In such an approach, instructions of the application may be stored locally (e.g., in storage 508), and data for use by the application is downloaded on a periodic basis (e.g., from the edge service network, from an out-of-band feed, from an Internet resource, or using another suitable approach). Control circuitry 518 may retrieve instructions of the application from storage 508 and process the instructions to provide functionality and perform any of the actions discussed herein. Based on the processed instructions, control circuitry 518 may determine what action to perform when input is received from user input interface 510. For example, head movement or movement of a hand or handheld device via user input interface 510. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the XR application may be downloaded and interpreted or otherwise run by an interpreter or virtual machine (run by control circuitry 518). In some embodiments, the XR application may be encoded in the ETV Binary Interchange Format (EBIF), received by control circuitry 518 as part of a suitable feed, and interpreted by a user agent running on control circuitry 518. For example, the XR application may be an EBIF application. In some embodiments, the XR application may be defined by a series of JAVA-based files that are received and run by a local virtual machine or other suitable middleware executed by control circuitry 518.

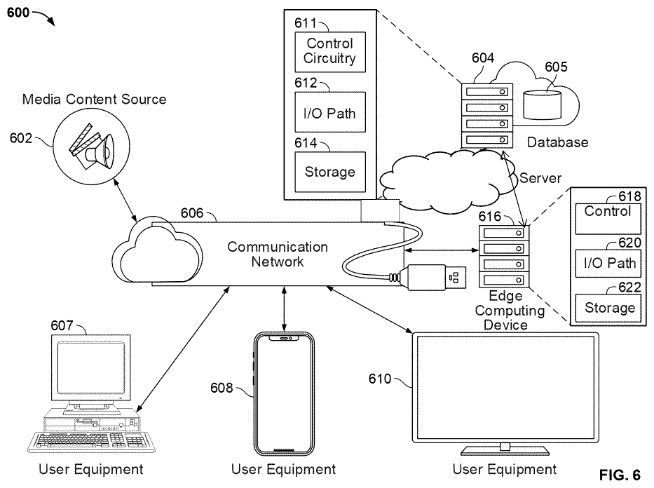

FIG. 6 is a diagram of an illustrative system 600, in accordance with some embodiments of this disclosure. User equipment devices 607, 608, 610 (e.g., which may correspond to one or more of device 103a-I or 107a-b, may be coupled to communication network 606. Communication network 606 may be one or more networks including=mobile voice or data network, which via one or more computing devices 616, such as APs 101, may connected via an additional network, for example, the Internet, mobile telephone network (e.g., a 5G, 4G, or LTE network), cable network, public switched telephone network, or other types of communication network or combinations of communication networks to a computing device 604, such as server 111. Paths (e.g., depicted as arrows connecting the respective devices to the communication network 606) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 6 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 606.

System 600 may comprise media content source 602, one or more servers 604 connected via a network, and one or more edge computing devices 616 (e.g., included as part of AP). In some embodiments, the AP application may be executed at one or more of control circuitry 618 of server 616.

In some embodiments, server 604 may include control circuitry 611 and storage 614 (e.g., RAM, ROM, Hard Disk, Removable Disk, etc.). Storage 614 may store one or more databases. Server 604 may also include an input/output path 612. I/O path 612 may provide AR generation data, device information, or other data, over a local area network (LAN) or wide area network (WAN), and/or other content and data to control circuitry 611, which may include processing circuitry, and storage 614. Control circuitry 611 may be used to send and receive commands, requests, and other suitable data using I/O path 612, which may comprise I/O circuitry. I/O path 612 may connect control circuitry 611 (and specifically control circuitry) to one or more communications paths.

Control circuitry 611 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 611 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 611 executes instructions for an emulation system application stored in memory (e.g., the storage 614). Memory may be an electronic storage device provided as storage 614 that is part of control circuitry 611.

Edge computing device 616 may comprise control circuitry 618, I/O path 620 and storage 622, which may be implemented in a similar manner as control circuitry 611, I/O path 612 and storage 624, respectively of server 604. Edge computing device 616 may be configured to be in communication with one or more of user equipment devices 607, 608, 610 and video server 604 over communication network 606, and may be configured to perform processing tasks. In some embodiments, a plurality of edge computing devices 616 may be strategically located at various geographic locations, and may be AP devices configured to provide processing support for mobile devices at various geographical regions.

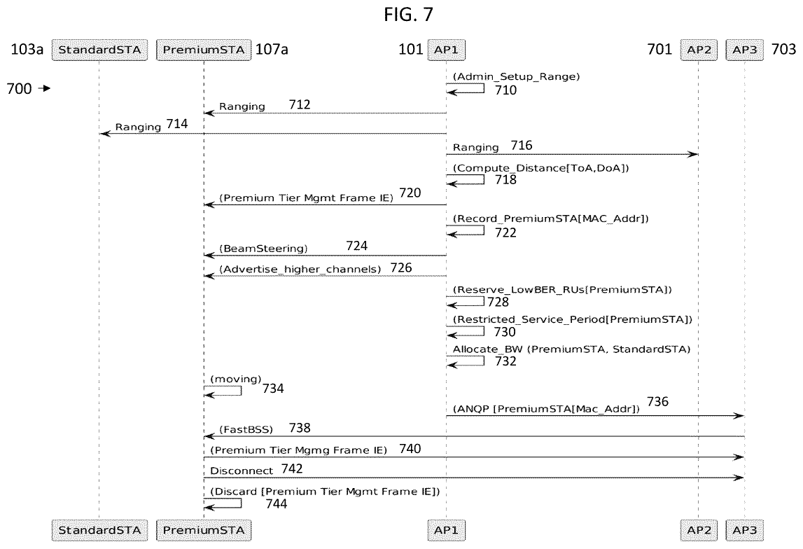

FIG. 7 is an example of communication and processing flow diagram showing a process 700 according to an aspect of the disclosure for Wi-Fi access point-initiated premium status request, according to an aspect of the disclosure. The methods or processes 700 may be implemented, in whole or in part, by the system(s) described herein and shown in the figures (such as any one or more of those shown in FIGS. 5-6). One or more actions of the depicted processes may be incorporated into or combined with one or more actions of any other process or embodiments described herein. The processes may be saved to a memory or storage (such as any one or more of those shown in FIGS. 5-6) as one or more instructions or routines that may be executed by a corresponding device or system to implement the process. Depending on the embodiment, one or more steps of the described process may be implemented or facilitated by a server.

As shown at 710 of FIG. 7, a first AP 101 (AP1) may set up a ranging process for determining locations of STAs. At 712, AP 101 may perform a ranging process 712 for STA 107a. For example, this may be the ranging process shown in FIG. 3 or in FIG. 4. Other types of location determination, for example, using GPS and SLAM (Simultaneous Localization and Mapping) or the like are also contemplated.

At 716, ranging calculations may be forwarded by AP 101 to AP 701 and/or to AP 703. AP 701 and AP 703 may also communicate their distance calculations to each other and/or to AP 101.

At 718, AP 101 may determine a distance to each of STA 103a and STA 107a. A location, or approximate location, of each of STA 103a and STA 107a, or a relative location to another device, such as to AP 101 and/or to another AP, may be determined to determine whether the STA 103a is located in a premium Wi-Fi accessing area. The premium Wi-Fi accessing area may use the same network service set (e.g. same SSID) on a Wi-Fi network as other areas. Further, more than one premium Wi-Fi accessing area may be recognized within the same service set. For example, a Wi-Fi network of a hotel may cover a VIP lounge in one location and a boardroom in an entirely different location of the hotel, both recognized as premium areas and separated by a non-premium Wi-Fi area. A premium service area may be serviced by two or more APs of the Wi-Fi network.

At 720, an information element, such a premium tier management frame, may be transmitted by AP 101 by to Wi-Fi accessing device STA 107. AP 101 may record a date and time at which premium status was granted to STA 107a. For example, the premium status may be granted for only a specific period of time. In an embodiment, STA 107a may provide a notification, for example, via a graphical user interface of the STA 107a, that the STA 107 has been upgraded to premium status and previous. Further, the basis for the granted premium status, for example, the location of the STA 107a in an area designated as premium status, and the boundaries of the designated area may also be communicated to a user at this time. In addition, aspects of the enhanced quality of service, for example, expected throughput rates, may also be communicated at this time. In addition, or instead, AP 101 may transmit a code, or other cryptological identification means, such as a private key, to the STA 107a so that the STA 107a may later identify itself to prove its premium device status.

At 722, AP 101 may record an identification of the STA 107a, such as a MAC address of the STA 107. AP 101 may transmit the identification of the STA 107a to a premium device server 111. For example, at future occasions of communication by the STA 107a to this AP 101 or to other APs, on this Wi-Fi network or on other Wi-Fi networks, the premium status of the device could then be checked in a database accessed by the premium device server 111. At 724, AP 101 may provide antenna beam steering for STA 107A to facilitate

enhanced communication. In addition, or instead, other measures may be taken for improving the quality of service (QoS) for STA 107a.

As shown at 726, higher frequency channels may be advertised to STA 107a. At 728, AP 101 may reserve a lower unit for STA 107a. At 730, AP 101 may determine that STA 107a will receive the premium status for a period of time. In an embodiment, the length of the period during which STA 107a is granted premium status may be determined in advance according to a premium status policy. For example, AP 101 may contact the premium device server 111 to check the length of this period, and/or to check other conditions of premium status for this class of premium status. The premium status policy may set forth various durations of this period, and/or may set forth various types of conditions for different class of premium status. By way of example, a first premium status class may be granted premium status anytime, anywhere within the W-Fi network. A second premium status class may be granted premium status only while the STA 107a is communicating in a premium area. A premium status class may be granted premium status only for a period of time, or only for a period of time while in the premium area, or only for a period of time while outside the premium area and always in the premium area, or only for a predetermined number of talk minutes and/or predetermined quantity of data transmissions, or the like, or for various combinations of such and/or other factors.

At 732, the AP 101 may allocate bandwidth for the STA 107a and for STA 103a according to their status as premium and non-premium, respectively. As discussed, allocating bandwidth based on premium status may be one of several techniques used to enhance QoS for STA 107a. Premium or non-premium status, as well as conditions or limitations of the premium status, may be determined by accessing a database 117 associated with the AP 101 and/or may be determined by accessing server 111, which may determine such status and conditions thereof based on data stored in its associated database 115.

At 734, the STA 107a may move to a different location within the Wi-Fi network area. In an embodiment, the STA 107a may provide a warning to the user if the STA 107a is moving, or has moved, from the premium service area to a standard (non-premium) area of the Wi-Fi network. The AP 101 may signal the STA 107a to provide such notification or warning. The AP 101 may detect that the STA 107a is no longer in the previous area, for example, using the ranging methods described above.

AP 101 may communicate to the STA 107a, for example, in the Access Network Query Protocol (ANQP) message, the range/distance of other APs of the Wi-Fi network, as shown at 736. In an embodiment, APs of the Wi-Fi network may inform the STA 107a, and/or request that STA 107 provide notification to its user, of Wi-Fi networks that provide premium status to the STA 107a. For example, it may be detected that the STA 107a is approaching a Wi-Fi network that will grant or recognize the premium status for the STA 107a and a map or directions to this Wi-Fi network may be output via the STA 107a.

As shown at 738, as the STA 107a roams, AP 3 (AP 703) may start fast Basic Service Set (BSS) transmissions between AP 101 by redefining the security key negotiation protocol, allowing both the negotiation and requests for wireless resources. STA 107a may either compute the range of a neighboring AP, or may be informed by AP 101 what channels are operated by the AP 703 that the STA 107A will be roaming to. In this way, STA 107a may avoid the need for channel scanning.

In an embodiment, even when premium STA 107a is no longer connected to the premium granting AP 101, STA 107a may still be treated by other APs using the same SSID in a premium manner.

New AP 703 may receive the information element from STA 107a at 740, and in response, the AP 703 may provide the enhanced QoS as described above to the STA 107a. Instead, or in addition, the new AP 701 may be informed by the AP 101 and/or by server 111 of the premium status of STA 107a.

In an embodiment, the AP 107a may notify the AP 703 of the premium status of STA 107a, for example, by transmitting the MAC address or a private key of the STA 107a to the AP 703. This notification may be done at time of handoff or anticipated handoff, at the time STA 107 is first granted premium status or is recognized by the AP 101 as having previously be entitled to premium status, or at other times. When at 742, the STA 107a disconnects from the Wi-Fi network, it may then, at 744, discard the information element that it had used to be granted premium status.

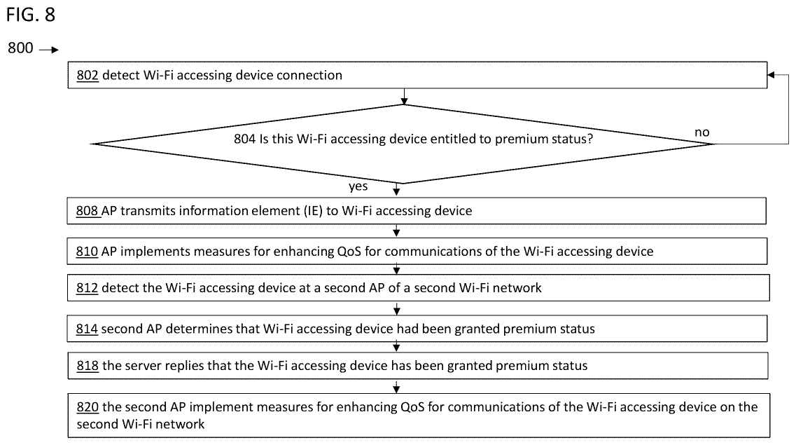

FIG. 8 is a flowchart showing a process 800 for premium status management, according to an aspect of the disclosure. The method or process 800 may be implemented, in whole or in part, by the system(s) described herein and shown in the figures (such as any one or more of those shown in FIGS. 5-6). One or more actions of the depicted processes may be incorporated into or combined with one or more actions of any other process or embodiments described herein. The processes may be saved to a memory or storage (such as any one or more of those shown in FIGS. 5-6) as one or more instructions or routines that may be executed by a corresponding device or system to implement the process. Depending on the embodiment, one or more steps of the described process may be implemented or facilitated by a server.

As shown at 802, AP 101 detects that Wi-Fi accessing device 107a (STA 107) is connecting to the AP 101.

At 804, AP 101 determines whether STA 107 is entitled to premium status. For example, AP 101 may determine the location of STA 107, or may check its own database 117 and/or may query premium device server 111 for the status of the STA 107.

At 808, AP 101 may transmit an information element (IE) to the STA 107 to be used for authorization of the STA 107 as a premium status device.

At 810, the AP 101 may implement measures as described herein for enhancing QoS for the STA 107a. Another AP of the Wi-Fi accessing network and/or other Wi-Fi networks may be notified of the premium status of STA 107, and a database containing the master list 115 at the server may be updated. One or more of the operations mentioned in this paragraph may be performed concurrently, or before, the operations performed in the previous paragraph.

At 812, a second AP may receive a transmission from Wi-Fi accessing device 107a (STA 107). The second AP may be part of the same Wi-Fi service set or may be part of a different Wi-Fi network.

At 814, the second AP may determine whether the Wi-Fi accessing device had been granted premium status the location of STA 107, or may check its own database 117 and/or may query premium device server 111 for the status of the STA 107. The second AP, at 816, may contact the premium device server 111 to check the status of the STA 107. The premium device server 111 may check the status of the STA 107, for example, by comparing a MAC address of the STA 107 and/or the IE received against a list of such data in its database 115.

At 818, the server 111 may reply to the second AP (of the same, or a different, Wi-Fi network) as to whether the STA 107 has premium status.

At 820, the second AP may implement measures as described herein for enhancing QoS for the STA 107a, if the second AP determines that the STA 107a has premium status. The second AP may transmit an information element (IE) to Wi-Fi accessing device. Another AP of the Wi-Fi accessing network and/or other Wi-Fi networks may be notified of the premium status of STA 107, and a database containing the master list 115 at the server may be updated. One or more of the operations mentioned in this paragraph may be performed concurrently, or before, other operations mentioned in this paragraph.

In an embodiment, the second information element may be identical to the first information element. For example, the second IE may be a similar code that was used in the first IE. In an embodiment, the STA 107a may identify itself to the second AP of the second Wi-Fi network using the same information element it had previously received from the first AP 101. The second AP may recognize any STA 107 transmitting this IE as being a premium status device. Or, a two-step authentication process may be used in which the second AP, upon receiving this IE, may automatically query the premium device server 111 to check the premium status of the STA 107.

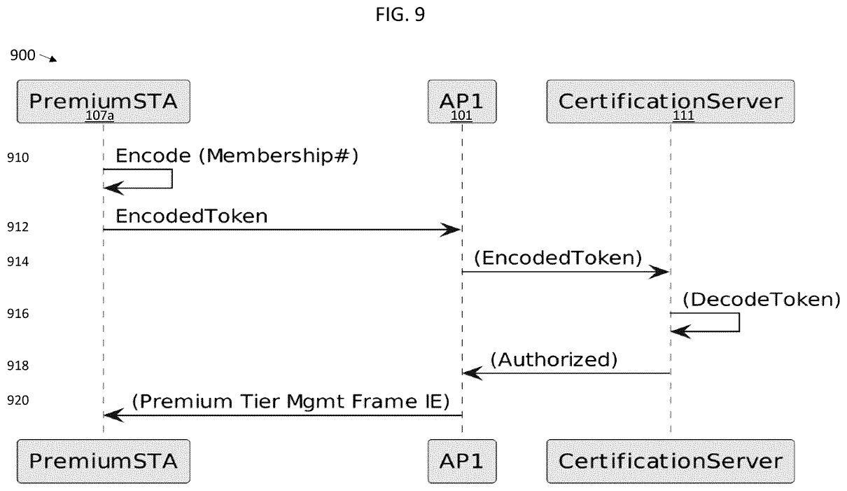

FIG. 9 is an example of communication and processing flow diagram showing a process for establishing premium status using a token. The method or process 900 may be implemented, in whole or in part, by the system(s) described herein and shown in the figures (such as any one or more of those shown in FIGS. 5-6). One or more actions of the depicted processes may be incorporated into or combined with one or more actions of any other process or embodiments described herein. The processes may be saved to a memory or storage (such as any one or more of those shown in FIGS. 5-6) as one or more instructions or routines that may be executed by a corresponding device or system to implement the process.

As discussed with regard to FIG. 1B, a Wi-Fi accessing device 107a, 107b may have a token or may have other cryptographic means for identifying itself to an AP as being entitled to premium status, regardless of location within a W-Fi area. For example, employees of a company may use smartphones with tokens to grant them the premium status.

At 910, the STA 107a may receive a membership number received from an application-level entity such as an app (e.g. an airline app, hotel app awarding loyalty points, etc.) and this may be processed by the STA 107.

At 912, the STA 107a may transmit a token evidencing this status to the AP 101. This token may be coded or scrambled (encryption or hashed). The token may include details about the particular customer (royalty number, subscriber ID, flight number, membership number . . . ), duration that the access will be active or other conditions governing the extent of premium status.

At 914, The AP 101 may transmit the token to an authentication server (certification server/premium device server 111) that may verify its contents and the status of the STA 107a.

At 918, the AP 101 may receive an authentication confirmation message from the certification server 111 confirming the premium status of the STA 107a. The AP 101 may record the MAC address of the STA 107a and provide enhanced QoS, as explained above. In an embodiment, the AP 101 may grant the premium status only if the STA 107 both transmits the token and is in a designated premium area within the physical area served by the Wi-Fi network.

As shown at 920, the AP 101 may transmit an IE to the STA 107a based on the authorization received from the server 111. In an embodiment, STA 107 may present credentials to server 111 and, in response, server 111 may transmit it the IE. The STA 107 may then transmit the IE to the AP 101, for example, automatically as part of its first communication, to obtain recognition from the AP 101 of the premium status of the STA 107 so that the AP 101 may implement measures for enhanced QoS for the STA 107. In an embodiment, such an IE transmitted to the AP 101 may also indicate a level of premium status of a tiered premium status hierarchy (e.g. VIP premium status or “regular” premium status), so that the AP 101 may take measures accordingly. In an embodiment, such an IE transmitted to the AP 101 may indicate conditions or limitations on the premium status (e.g. premium status for one hour, or premium status for one stay in the hotel Sep. 15-19, 2025), or other conditions or limitations as discussed herein.

In an embodiment, AP 101 may receive in advance one or more lists of STAs (e.g. their MAC addressed) entitled to premium status, or may receive in advance one or more codes (e.g. tokens, private keys) used by STAs entitled to premium status. Based on this previously stored information, the AP 101 may recognize STA 107a as having premium status without the need to contact the certification server for authentication. In an embodiment, the token provided from the application may also be coded in a manner to assign further hierarchical tiering of premium STAs.

A technological solution provided according to an aspect of the disclosure using one or more of the foregoing techniques, and other techniques described herein, is that a better quality of service may be provided for select Wi-Fi accessing devices to which premium status is granted. Such improved service quality may yield one or more of increased throughout, when downloading and/or when uploading, fewer lost packets or collisions, fewer dropped calls and connections, improved signal-to noise ratio, reduced latency during handoff, and the like. Two or more of the foregoing techniques may be used in combination, and other such techniques not specifically described herein that provide enhanced quality of service for Wi-Fi accessing devices may also be used.

Also, while sometimes discussed as two tiers of service quality-premium and standard (non-premium)—three or more tiers of service quality may be provided. For example, a combination of two or more of the foregoing quality of service enhancement techniques, or all of the foregoing quality of service enhancement techniques, as well as others, may be used to provide a VIP quality of service for one or more select Wi-Fi accessing device(s).

The term “and/or,” may be understood to mean “either or both” of the elements thus indicated. Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Components or processes described as separate may be combined or combined in ways other than as described, and components or processes described as being together or as integrated may be provided separately. Steps or processes described as being performed in a particular order may be re- ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

It should also be noted that the systems and/or methods described above may be applied to, or used in accordance with, other systems and/or methods. In various embodiments, additional elements may be included, some elements may be removed, and/or elements may be arranged differently from what is shown. Alterations, modifications and variations can be affected to the particular embodiments by those of skill in the art without departing from the scope of the present application, which is defined solely by the claims appended hereto.

1. A method comprising:
determining that a first Wi-Fi accessing device is associated with a premium status on a Wi-Fi service network;
causing a Wi-Fi access point (AP) to transmit to the first Wi-Fi accessing device an information element indicating the premium status;
receiving an indication of communication from the first Wi-Fi accessing device at the AP; and
causing the AP to provide a first level of service for communication between the first Wi-Fi accessing device and the AP according to the premium status for the first Wi-Fi accessing device indicated by the information element, wherein the first level of service provides enhanced quality of service for communications of the first Wi-Fi accessing device compared with a second level of service on the Wi-Fi service network provided for communications of a second Wi-Fi accessing device.

2. The method of claim 1, wherein the AP is a first AP, and the Wi-Fi service network is a first Wi-Fi service network, and wherein the method further comprises:
receiving an indication of a second communication from the first Wi-Fi accessing device, wherein the second communication comprises the information element and is received over a second Wi-Fi service network by a second AP remote from the first AP, wherein the second Wi-Fi service network is remote from the first Wi-Fi service network; and
causing the second AP to provide the first level of service on the second Wi-Fi service network for communications of the first Wi-Fi accessing device, wherein the second AP provides the second level of service on the Wi-Fi service network for communication between a third Wi-Fi accessing device and the second AP.

3. The method of claim 1, wherein the causing the AP to transmit to the first Wi-Fi accessing device the information element comprises:
determining by a server that the first Wi-Fi accessing device is eligible for the premium status; and
transmitting, by the server, a request to the AP to transmit to the first Wi-Fi accessing device the information element conferring the premium status.

4. The method of claim 1, further comprising:
determining that the premium status of the first Wi-Fi accessing device expires after a period of time; and
causing the AP to provide the second level of service on the Wi-Fi service network for communications of the first Wi-Fi accessing device with the AP.

5. The method of claim 1, wherein the determining that the first Wi-Fi accessing device has
premium status comprises:
determining that the first Wi-Fi accessing device is located in a first physical area different from a second physical area, wherein the first physical area and the second physical area are within a signal range of the Wi-Fi service network; and
further comprising:
allocating the second level of service on the Wi-Fi service network for communications of the second Wi-Fi accessing device with the AP by determining that the second Wi-Fi accessing device is located in the second physical area.

6. The method of claim 1, further comprising:
storing in a memory a first MAC address of the first Wi-Fi accessing device;
after receiving a signal from the first Wi-Fi accessing device, determining that the first Wi-Fi accessing device has a MAC address that matches the first MAC address; and
granting the first level of service based at least in part on the determining that the first Wi-Fi accessing device has a MAC address that matches the first MAC address.

7. The method of claim 1, wherein the enhanced quality of service for the first Wi-Fi accessing device is obtained by:
causing allocation of a first radiofrequency band of the Wi-Fi service network to a first plurality of Wi-Fi accessing devices, including the first Wi-Fi accessing device, for communicating with the AP, and causing allocation of a second radiofrequency band of the Wi-Fi service network to a second plurality of Wi-Fi accessing devices, including the second Wi-Fi accessing device, for communicating with the AP.

8. The method of claim 7, further comprising:
selectively advertising, by the AP, the first radio frequency band on the Wi-Fi service network.

9. The method of claim 1, wherein the enhanced quality of service for the first Wi-Fi accessing device is obtained by:
causing allocation of a first resource unit of the Wi-Fi service network to the first Wi-Fi accessing device, and causing allocation of a second resource unit of the Wi-Fi service network to the second Wi-Fi accessing device,
wherein the first resource unit provides a higher modulation coding scheme than the second resource unit.

10. The method of claim 1, wherein the enhanced quality of service for the first Wi-Fi accessing device is obtained by:
steering an antenna radio beam of the AP to favor communications at a location of the first Wi-Fi accessing device.

11. The method of claim 1, wherein the AP is a first AP, and the enhanced quality of service for the first Wi-Fi accessing device is obtained by:
communicating to a second AP to anticipate handoff of the first Wi-Fi accessing device from the first AP to the second AP.

12. The method of claim 1, wherein the enhanced quality of service for the first Wi-Fi accessing device is obtained such that the second level of service is free of a maximum bandwidth egress limitation controlled by a setting of the AP for the second Wi-Fi accessing device and free of a maximum bandwidth ingress limitation controlled by a setting of the AP for the second Wi-Fi accessing device.

13. The method of claim 1, wherein the enhanced quality of service for the first Wi-Fi accessing device is obtained by prioritizing the first Wi-Fi accessing device in a transmission queue using Restricted Service Periods (RSP).

14. The method of claim 1 wherein the AP is a first AP, and the method further comprises:
receiving an indication of a second communication from the first Wi-Fi accessing device, wherein the second communication comprises the information element and is received by a second AP of the Wi-Fi service network; and
causing the second AP to provide the first level of service for communications of the first Wi-Fi accessing device.

15. A system comprising:
a memory;
control circuitry configured:
to determine that a first Wi-Fi accessing device is associated with a premium status on a Wi-Fi service network;
to cause a Wi-Fi access point (AP) to transmit to the first Wi-Fi accessing device an information element indicating the premium status, and storing in the memory an indication of the premium status for the first Wi-Fi accessing device;
to receive an indication of communication from the first Wi-Fi accessing device at the AP; and
to cause the AP to provide a first level of service for communication between the first Wi-Fi accessing device and the AP according to the premium status for the first Wi-Fi accessing device indicated by the information element, wherein the first level of service provides enhanced quality of service for communications of the first Wi-Fi accessing device compared with a second level of service on the Wi-Fi service network provided for communications of a second Wi-Fi accessing device.

16. The system of claim 15, wherein the AP is a first AP, and the Wi-Fi service network is a first Wi-Fi service network, and wherein the instructions are configured:
to receive an indication of a second communication from the first Wi-Fi accessing device, wherein the second communication comprises the information element and is received over a second Wi-Fi service network by a second AP remote from the first AP, wherein the second Wi-Fi service network is remote from the first Wi-Fi service network; and
to cause the second AP to provide the first level of service on the second Wi-Fi service network for communications of the first Wi-Fi accessing device, wherein the second AP provides the second level of service on the Wi-Fi service network for communication between a third Wi-Fi accessing device and the second AP.

17. The system of claim 15, wherein the causing the AP to transmit to the first Wi-Fi accessing device the information element comprises:
determining by a server that the first Wi-Fi accessing device is eligible for the premium status; and
transmitting, by the server, a request to the AP to transmit to the first Wi-Fi accessing device the information element conferring the premium status.

18. The system of claim 15, wherein the instructions are configured:
to determine that the premium status of the first Wi-Fi accessing device expires after a period of time; and
to cause the AP to provide the second level of service on the Wi-Fi service network for communications of the first Wi-Fi accessing device with the AP.

19. The system of claim 15, wherein the determining that the first Wi-Fi accessing device has
premium status comprises:
determining that the first Wi-Fi accessing device is located in a first physical area different from a second physical area, wherein the first physical area and the second physical area are within a signal range of the Wi-Fi service network; and
allocating the second level of service on the Wi-Fi service network for communications of the second Wi-Fi accessing device with the AP by determining that the second Wi-Fi accessing device is located in the second physical area.

20. The system of claim 15, wherein the instructions are configured:
to store in a memory a first MAC address of the first Wi-Fi accessing device;
after receiving a signal from the first Wi-Fi accessing device, to determine that the first Wi-Fi accessing device has a MAC address that matches the first MAC address; and
to grant the first level of service based at least in part on the determining that the first Wi-Fi accessing device has a MAC address that matches the first MAC address.

21.-70. (canceled)
